(19) United States
(12) Patent Application Publication
(10) Pub. No.: US 2019/0246679 A1
(43) Pub. Date: Aug. 15, 2019

(54) Fortified Micronutrient Food and Beverage Additive

(71) Applicants: Kyle Murphy, (US); Frederick T Murphy, (US)

(72) Inventors: Kyle Murphy, Hollidaysburg, PA (US); Frederick T Murphy, Hollidaysburg, PA (US)

(21) Appl. No.: 16/362,302

(22) Filed: Mar. 22, 2019

Related U.S. Application Data
(63) Continuation-in-part of application No. 15/445,119, filed on Feb. 28, 2017.
(60) Provisional application No. 62/301,024, filed on Feb. 29, 2016.

(51) Int. Cl. A23L 33/155; A23L 33/16; A23L 27/16; A23L 27/14; A23L 27/10

(52) U.S. Cl. CPC A23L 33/155; A23L 33/16; A23V 2002/00; A23L 27/14; A23L 27/105; A23L 27/16

(57) ABSTRACT

A food and beverage additive may include a micronutrient fortification supplement which includes at least 10 different micronutrients and a flavoring agent which includes at least one seasoning or spice. A food and beverage additive may include Vitamin A, Vitamin B1, Vitamin B2, Vitamin B3, Vitamin B5, Vitamin B6, Vitamin B7, Vitamin B9, Vitamin B12, Vitamin C, Vitamin D2, Vitamin E, Vitamin K1, Zinc, Chromium, Copper, Iodine, Iron, Manganese, Molybdenum, Selenium, and a flavoring agent which includes at least one seasoning or spice. The micronutrients in the compositions may be 100% plant-based and may be present in the food and beverage additives in an amount equal to or greater than the Daily Value (DV) of the U.S. Food and Drug Administration (FDA).

### CROSS-REFERENCE TO RELATED APPLICATION

This application is a continuation-in-part of U.S. patent application Ser. No. 15/445,119, filed Feb. 28, 2017, which claims benefit of priority from U.S. Provisional Patent Application No. 62/301,024, filed Feb. 29, 2016, both of which are incorporated herein by reference in their entireties.

### BACKGROUND

### Field of the Invention

This disclosure relates to fortified micronutrient products, and, in particular, fortified micronutrient products to treat malnutrition and micronutrient deficiencies and related conditions, diseases, and defects in children and adults.

### Description of Related Art

Malnutrition and micronutrient deficiencies in children are protean complications associated with a myriad of nutritional barriers including: poor economic status and poverty, monotonous diets with abundant micronutrient deficiencies, low animal source foods, low prevalence of breastfeeding, increased physiological demands for growth during pregnancy, poor general nutritional status, seasonal variations in food availability, and food shortages, as well as complications associated with malabsorption due to prevalent protozoan, parasitic, and vector borne infectious diseases indigenous within certain regions of the world.

It is estimated that nearly 2 billion people in the world today suffer from micronutrient deficiencies caused largely by a dietary deficiency of vitamins and minerals. The public health importance of these deficiencies lies upon their magnitude and their health consequences, especially in pregnant women and young children, as they affect fetal and child growth, cognitive development, and resistance to infection.

Although people in all population groups in all regions of the world may be affected, the most widespread and severe problems are usually found amongst resource poor, food insecure, and vulnerable households in developing countries. Poverty, lack of access to a variety of foods, lack of knowledge of appropriate dietary practices, and high incidence of infectious diseases are key factors.

Micronutrient malnutrition (MNM) is widespread in the industrialized nations, but even more so in the developing regions of the world. It can affect all age groups, but young children and women of reproductive age tend to be among those most at risk of developing micronutrient deficiencies. Micronutrient malnutrition has many adverse effects on human health, not all of which are clinically evident. Even moderate levels of deficiency can have serious detrimental effects on human function. Thus, in addition to the obvious and direct health effects, the existence of MNM has profound implications for economic development and productivity, particularly in terms of the potentially huge public health costs and the loss of human capital formation.

Worldwide, the three most common forms of MNM are iron, Vitamin A and iodine deficiency. Together, these affect at least one third of the world's population, the majority of whom are in developing countries. Of the three, iron deficiency is the most prevalent. It is estimated that just over 2 billion people are anemic, just under 2 billion have inadequate iodine nutrition and 254 million preschool-aged children are Vitamin A deficient.

Micronutrient malnutrition is thus a major impediment to socio-economic development contributing to a vicious cycle of under development and to the detriment of already underprivileged groups. It has long-ranging effects on health, learning ability, and productivity, and has high social and public costs leading to reduced work capacity due to high rates of illness and disability.

Thus, there exists a need for a micronutrient fortification system that is effective to address these problems, is easily transportable, is sanitary, and can be easily applied to any food or meal of a particular subject or patient.

### SUMMARY OF THE INVENTION

A food and beverage additive according to an embodiment of the present disclosure includes a micronutrient fortification supplement and a flavoring agent. The micronutrient fortification supplement may include at least 10 different micronutrients and the flavoring agent may include at least one seasoning or spice.

A food and beverage additive according to an embodiment of the present disclosure may include a micronutrient fortification supplement which includes: Vitamin A, Vitamin B1, Vitamin B2, Vitamin B3, Vitamin B5, Vitamin B6, Vitamin B7, Vitamin B9, Vitamin B12, Vitamin C, Vitamin D2, Vitamin E, Vitamin K1, Zinc, Chromium, Copper, Iodine, Iron, Manganese, Molybdenum, and Selenium. The food and beverage additive includes a flavoring agent which may include at least one seasoning or spice.

The compositions could be powder and/or could be granular. They could be configured to be added to a food or beverage product, such as a prepared food or beverage product.

The effective amounts of each of the ingredients may be selected to be effective to treat one or more of the conditions, diseases, or defects described herein in this disclosure.

Additional examples of embodiments of the present disclosure and other details and advantages will be evident upon examining the examples illustrated in the following detailed description and claims.

### BRIEF DESCRIPTION OF THE DRAWINGS

FIG. 1 is a view of a fortified micronutrient product according to an embodiment of the present invention being applied to a prepared food product; and

FIG. 2 is a schematic view of a method of manufacturing the fortified micronutrient product of FIG. 1.

### DESCRIPTION OF THE INVENTION

As used herein, the “treatment” or “treating” of a condition, disease, or defect means administration to a patient by any suitable dosage regimen and administration route of a composition with the object of achieving a desirable clinical/medical end-point, including attracting progenitor cells, healing a wound, correcting a defect, etc. As used herein, the terms “patient” or “subject” refer to members of the animal kingdom including but not limited to mammals and human beings and is not limited to humans or animals in a doctor-patient or veterinarian-patient relationship. It is also to be understood that the specific apparatuses and configurations illustrated in the attached drawings, and described in the following specification, are simply exemplary embodiments of the invention and are not to be construed as limiting.

According to one non-limiting example, an embodiment of a micronutrient fortification supplement according to the present disclosure herein may include a formulated composition, such as a supplement product, with one or more additional pharmaceutically or nutritionally acceptable excipients, e.g., vehicles or diluents for oral administration.

An excipient is an inactive substance used as a carrier for the active ingredients of a composition, though “inactive”, excipients may facilitate and aid in increasing the delivery or bioavailability of an active ingredient in a product. Non-limiting examples of useful excipients include: anti-adherents, binders, rheology modifiers, coatings, disintegrants, emulsifiers, oils, buffers, salts, acids, bases, fillers, diluents, solvents, flavors, colorants, glidants, lubricants, preservatives, antioxidants, sorbents, vitamins, sweeteners, etc., as are available in the pharmaceutical/compounding arts (see, generally, Troy, D B, Editor, Remington: The Science and Practice of Pharmacy, 21st Ed., Lippincott Williams & Wilkins (2005) incorporated herein by reference in its entirety). Additional excipients, such as polyethylene glycol, emulsifiers, salts, and buffers may be included.

The use of numerical values in the various ranges specified in this application, unless expressly indicated otherwise, are stated as approximations as though the minimum and maximum values within the stated ranges are both preceded by the word “about”. In this manner, slight variations above and below the stated ranges can be used to achieve substantially the same results as values within the ranges. Also, unless indicated otherwise, the disclosure of ranges is intended as a continuous range including every value between the minimum and maximum values, including the minimum and maximum values, as well as all subranges subsumed therein. As used herein “a” and “an” refer to one or more.

A “micronutrient”, as used herein, refers to a chemical element or substance required for human nutrition in small quantities throughout life. Micronutrients include vitamins and minerals. Examples of micronutrients include calcium, nitrogen, magnesium, phosphorus, potassium, sodium, boron, cobalt, chromium, copper, iodine, iron, manganese, molybdenum, selenium, zinc, Vitamin B1, Vitamin B2, Vitamin B3, Vitamin B5, Vitamin B6, Vitamin B7, Vitamin B9, Vitamin B12, choline, Vitamin A, Vitamin C, Vitamin D2, Vitamin D3, Vitamin E, Vitamin K1, and Vitamin K2.

The embodiments of the present disclosure are a scientifically developed, micronutrient fortification supplement, well-positioned to breach existing inherent entry barriers associated with the management of malnutrition in children in developing nations. The embodiments of the present disclosure provide a high impact, low cost nutritional supplement that provides a delivery system rich in fortified micronutrients through a sensible application platform with minimal storage space requirements and little or no preparation necessary, while providing a gateway to affected communities and individuals through easily transportable biodegradable sachets.

The embodiments of the present disclosure are uniquely positioned to meet the culturally diverse needs of childhood malnutrition and micronutrient deficiencies in vast and remote regions of the world. The embodiments of the present disclosure combine a unique blend of nutrient and micronutrient requirements in recommended daily allowances, which meet or exceed the Food and Agriculture Organization of the United Nations (FAO) and World Health Organization (WHO) Recommended Nutrient Intake (RNI) Guidelines. The embodiments of the present disclosure may contain each micronutrient in an amount which is equal to or greater than the Daily Value (DV) of the U.S. Food and Drug Administration (FDA). In addition, the micronutrient fortification compositions and product embodiments of the present disclosure are unique in their composition of natural spices and flavors, many of which are indigenous to the regions of the world in which they may be utilized. This can provide an opportunity to provide sustainable renewable nutrients to the benefit of local communities and villages. Another unique characteristic is the utilization of marginal amounts of fluoride to combat poor childhood dentition or dental decay in developing nations. Barriers to healthcare access and the absence of dental hygiene products portend tooth decay and poor childhood dentition, which may further lead to inadequate nutritional consumption throughout childhood into adulthood.

Applications of the embodiments of the present disclosure include: Home Based Infant/Child Fortification Programs in Developing Nations; School Based Fortification Programs in Developing Nations; Orphanage Based Fortification Programs in Developing Nations; Hospital & Clinic Based Fortification Programs in Developing Nations; Mission Driven Fortification Programs in Developing Nations; Non-Profit (NPO) Driven Fortification Programs in Developing Nations; Regional Government Related (GRO) Fortification Programs; Food & Agriculture Organization of the United Nations (FAO); World Health Organization (WHO); The National Academy of Sciences (NAS); The Gates Foundation; Refugee Camp Fortification Programs; Emergency Response (Earthquake, Tsunami, etc.) Fortification Programs; Armed Services (MRE) Fortification Programs; and other similarly situated applications. However, the embodiments herein can be use in connection with any application in which nutrient fortification is required

An embodiment of a micronutrient fortification supplement may include a composition of effective amounts of a collection of outcome driven nutrients and micronutrients developed and designed to meet and/or exceed the WHO guidelines.

Evidenced based nutritional guidelines have been established and validated by a number of regulatory agencies including the FAO and WHO Recommended Nutrient Intake (RNI) Guidelines and the DV guidelines of the FDA. In addition, the NAS has also developed Recommended Daily Amounts (RDA) for multiple micronutrient fortification.

Some embodiments of a micronutrient fortification supplement according to the present disclosure integrate the Estimated Average Requirement (EAR), Recommended Nutrient Intake (RNI), Dietary Reference Index (DRI), Recommended Daily Allowances (RDA), Daily Values (DV) of these organization guidelines to create a comprehensive protective nutrient intake sachet equipped to combat the most common childhood micronutrient deficiencies. Thus, the embodiments identified herein after can comply with all of the EAR, RDA, RNI, DRI, and FDA guidelines. A person of ordinary skill in the art will recognize that a sachet is a small bag or packet, such as, for example, a sugar packet or spice packet. Although the present disclosure contemplates that the sachet may be the size of sugar packet, the sachet according to embodiments of the present disclosure are not so limited.

The embodiments of the present invention are developed largely, but not exclusively, to meet the nutritional micronutrient requirements of children. The embodiments of the present disclosure should not exceed the generally regarded as safe micronutrient levels nor the recommended upper limit of micronutrient fortification. However, it should be understood that in instances where exceeding such level or limits is necessary for a particular application, such instances are contemplated to be encompassed within the present disclosure.

For the majority of micronutrients, the highest acceptable intake recommendations are for adult males. This sub-population usually has the lowest risk of micronutrient deficiencies due to higher food intake and lower micronutrient requirements per unit body weight.

Although the embodiments of the present invention have been developed to fulfill the micronutrient needs of individuals at most risk of not meeting their RNIs (e.g., young children and women of reproductive age), it is contemplated that in some instances, adult males would benefit as well. Some of these at risk groups may have at times even higher than normal requirements for specific micronutrients.

Embodiments of a micronutrient fortification supplement according to the present disclosure may include Vitamin A, such as in the form of β-carotene. Vitamin A is an essential nutrient that is required in small amounts by humans for the normal functioning of the visual system, the maintenance of cell function for growth, epithelial cellular integrity, immune function, and reproduction. Dietary requirements for Vitamin A are normally provided as a mixture of pre-formed Vitamin A (retinol), which is present in animal source foods, and pro-Vitamin A carotenoids, such as β-carotene, which are derived from foods of vegetable origin and which have to be converted into retinol by tissues, such as the intestinal mucosa and the liver, in order to be utilized by cells.

Vitamin A deficiency is the leading cause of preventable severe visual impairment and blindness in children, and significantly increases their risk of severe illness and death. An estimated 250,000-500,000 Vitamin A-deficient children become blind every year, approximately half of which die within a year of becoming blind. Subclinical Vitamin A deficiency is also associated with an increased risk of child mortality, especially from diarrhea and measles. Food fortification with Vitamin A is highly cost-effective in reducing mortality in children, as is supplementation with iron in pregnant women.

Vitamin A deficiency also increases vulnerability to other disorders, such as iron deficiency. Providing an iron supplement with Vitamin A to pregnant women in Indonesia increased hemoglobin concentrations by approximately 10 g/l more than did supplementation with iron alone.

Vitamin A may be sourced from animal foods, in particular, liver, eggs, and dairy products, which contain Vitamin A in the form of retinol. Thus, what is intended by the present disclosure is a form that can be readily used by the body. It is not surprising then that the risk of Vitamin A deficiency is strongly inversely related to intakes of Vitamin A from animal source foods. In fact, it is difficult for children to meet their requirements for Vitamin A if their diet is low in animal source foods, especially if their diet is also low in fat. Fruits and vegetables contain Vitamin A in the form of carotenoids, the most important of which is beta-carotene.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Vitamin A supplementation. A micronutrient fortification supplement according to the present disclosure may comprise Vitamin

A, per dose, in an amount of from 100 μg RAE (retinol activity equivalents) to 1500 μg RAE, such as from 300 μg RAE to 1300 μg RAE, or from 500 μg RAE to 1000 μg RAE, such as 900 μg RAE.

Embodiments of a micronutrient fortification supplement according to the present disclosure may contain iron. Iron deficiency is the most common and widespread nutritional disorder in the world. It is a public health problem in both industrialized and non-industrialized countries. Iron deficiency is the result of a long-term negative iron balance; in its more severe stages, iron deficiency causes anemia. Anemia is defined as a low blood hemoglobin concentration. The terms “iron deficiency” and “iron-deficiency anemia” are often used synonymously, although they are in fact not the same condition. About 40% of the world's population (i.e. more than 2 billion individuals) is thought to suffer from anemia, i.e., low blood hemoglobin.

The effectiveness of iron fortification has been demonstrated in several world regions. Iron fortification of infant formulas has been associated with a fall in the prevalence of anemia in children aged less than 5 years in the United States. Fortification of milk with iron and Vitamin C (ascorbic acid) in Chile produced a rapid reduction in the prevalence of iron deficiency in infants and young children. The effectiveness of the fortification of soy sauce with iron is currently being evaluated in a population of 10000 Chinese women and children with a high risk of anemia. Preliminary results of the 2-year double-blind placebo-controlled study have shown a reduction in anemia prevalence rates for all age groups after the first 6 months.

Embodiments of a micronutrient fortification supplement according to the present disclosure may be formulated to meet and/or exceed the FAO and WHO RNIs and EARs, DVs of the FDA, and/or the NAS DRI & RDA guidelines regarding iron supplementation. A micronutrient fortification supplement according to the present disclosure may comprise iron, per dose, in an amount of from 1 mg to 30 mg, such as from 7 mg to 27 mg, or from 10 mg to 20 mg, such as 18 mg.

Embodiments of a micronutrient fortification supplement according to the present disclosure may contain iodine. Iodine is present in the body in minute amounts, mainly in the thyroid gland. Iodine deficiency is a major public health problem for populations throughout the world, but particularly for young children and pregnant women, and in some settings represents a significant threat to national social and economic development. The most devastating outcome of iodine deficiency is mental retardation. It is currently one of the world's main causes of preventable cognitive impairment. This is the primary motivation behind the current worldwide drive to eliminate iodine deficiency disorders (IDD).

According to recent WHO estimates, some 1,989 million people have inadequate iodine nutrition. The WHO regions, ranked by the absolute number of people affected are, in decreasing order of magnitude, South-East Asia, Europe, the Western Pacific, Africa, the Eastern Mediterranean, and the Americas. In some parts of the world, for example, in parts of eastern and western Europe, iodine deficiency, in its subclinical form, is re-emerging, having previously been eliminated. This underscores the need to sustain efforts to control iodine deficiency on a global scale.

The main factor responsible for the development of iodine deficiency is a low dietary supply of iodine. This tends to occur in populations living in areas where the soil has been deprived of iodine as the result of past glaciation, and, subsequently, because of the leaching effects of snow, water, and heavy rainfall.

Goiter and cretinism are the most visible manifestations of iodine deficiency. Others include hypothyroidism, decreased fertility rate, increased perinatal death and infant mortality.

Irreversible mental retardation is the most serious disorder induced by iodine deficiency. A deficit in iodine resulting in thyroid failure during the critical period of brain development, that is, from fetal life up to the third month after birth, will result in irreversible alterations in brain function. In areas of severe endemic iodine deficiency, cretinism may affect up to 5-15% of the population. Some individuals living in regions of mild or moderate iodine deficiency exhibit neurological and intellectual deficits that are similar to, but less marked, than those found in overt cretins.

Both iodine and iron fortification have the potential to achieve high cost benefit ratios, given the prevailing levels of micronutrient deficiency and the economic situation of many low income countries. Potassium iodate is preferred to potassium iodide for salt iodization because it is more stable.

Embodiments of a micronutrient fortification supplement according to the present disclosure may be formulated to meet and/or exceed the FAO and WHO RNIs and EARs, DVs of the FDA, and/or the NAS DRI & RDA guidelines regarding iodine supplementation. A micronutrient fortification supplement according to the present disclosure may comprise iodine, per dose, in an amount of from 50 μg to 300 μg, such as from 90 μg to 290 μg, or from 100 μg to 200 μg, such as 150 μg.

Embodiments of a micronutrient fortification supplement according to the present disclosure may contain zinc. Zinc is an essential component of a large number of enzymes, and plays a central role in cellular growth and differentiation in tissues that have a rapid differentiation and turnover, including those of the immune system and those in the gastrointestinal tract. The positive impact of zinc supplementation on the growth of some stunted children, and on the prevalence of selected childhood diseases such as diarrhea, suggests that zinc deficiency is likely to be a significant public health problem, especially in developing countries. However, the extent of zinc deficiency worldwide is not well documented. All population age groups are at risk of zinc deficiency, but infants and young children are probably the most vulnerable.

There are several good reasons to suspect that zinc deficiency is common, especially in infants and children. Firstly, a high prevalence of low plasma zinc, which is a reasonable indicator of relatively severe depletion, has been observed in some population groups. Secondly, several randomized control trials have demonstrated that stunted children, and/or those with low plasma zinc, respond positively to zinc supplementation, a finding that suggests that zinc deficiency was a limiting factor in their growth. Growth stunting affects about a third of children in less wealthy regions of the world and is very common in settings where diets are of poor quality. This is not to say that zinc deficiency affects up to one third of children in the developing world since zinc deficiency is only but one of several possible causes of growth stunting.

Principal risk factors for zinc deficiency include diets low in zinc or high in phytates, malabsorption disorders (including the presence of intestinal parasites and diarrhea), impaired utilization of zinc and genetic diseases (e.g., acrodermatitis enteropathica, sickle-cell anemia).

Embodiments of a micronutrient fortification supplement according to the present disclosure may be formulated to meet and/or exceed the FAO and WHO RNIs and EARs, DVs of the FDA, and/or the NAS DRI & RDA guidelines regarding zinc supplementation. A micronutrient fortification supplement according to the present disclosure may comprise zinc, per dose, in an amount of from 1 mg to 15 mg, such as from 3 mg to 13 mg, or from 8 mg to 12 mg, such as 11 mg.

Embodiments of a micronutrient fortification supplement according to the present disclosure may be formulated to contain Vitamin D. The term “Vitamin D”, as used herein, refers to one or both of the D vitamins, Vitamin D2 and Vitamin D3. Vitamin D is one of the most important regulators of calcium and phosphorus homeostasis. It also plays many roles in cell differentiation and in the secretion and metabolism of hormones, including parathyroid hormone and insulin. Vitamin D (calciferol) is synthesized in the skin of most animals, including humans, from its precursor, 7-dehydrocholesterol, by the action of sunlight. This produces a naturally occurring form of the vitamin known as Vitamin D3. Vitamin D can also be obtained from the diet, either as Vitamin D3 or as a closely-related molecule of plant origin known as Vitamin D2. Since humans metabolize both forms in much the same way, from a nutritional perspective, Vitamin D3 and Vitamin D2 can be considered to be equivalent. Vitamin D3 is metabolized first in the liver to 25-hydroxyvitamin D (25-OH-D3), and then in the kidney to 1,25-dihydroxyvitamin D (1,25-(OH)2-D3), which is the biologically active form of the vitamin.

Severe Vitamin D deficiency produces the bone disease called rickets in infants and children and osteomalacia in adults, conditions that are characterized by the failure of the organic matrix of bone to calcify. The global prevalence of Vitamin D deficiency is uncertain, but it is likely to be fairly common worldwide, and especially among infants and young children, the elderly and those living at high latitudes where daylight hours are limited in the winter months.

Children living in the far northerly latitudes, whose exposure to ultraviolet light is low especially during the winter months, are at high risk for rickets. Vitamin D deficiency is also common in adults living at higher latitudes, for instance, surveys carried out in China after winter in populations living at about 41° N found that 13-48 percent of adults were deficient in this vitamin, with the highest prevalence occurring in older men. In Beijing, for example, 45 percent of adolescent girls were found to be deficient.

Approximately 80 percent of the Vitamin D in the body is produced in the skin.

Being naturally present in relatively few foods, dietary sources of Vitamin D usually supply only a small fraction of the daily requirements for the vitamin. Salt-water fish, such as herring, salmon, sardines, and fish liver oil are the main dietary sources. Small quantities of Vitamin D are found in other animal products (e.g. beef and butter), and if hens are fed Vitamin D, eggs can provide substantial amounts of the vitamin. Because the consumption of these foods tends to be relatively low, in industrialized countries, most dietary Vitamin D comes from fortified milk and margarine. Milk only provides small amounts of Vitamin D unless it is fortified.

Several studies have shown that the effects of poor Vitamin D status are exacerbated by low calcium intakes.

The clinical features of rickets include bone deformities and changes in the costochondral joints. Lesions are reversible after correction of Vitamin D deficiency. In osteomalacia, in which the loss of calcium and phosphorus from bone causes it to lose strength, the main symptoms are muscular weakness and bone pain, but little bone deformity. Osteomalacia contributes to osteoporosis, a condition in which the bone becomes more brittle and porous due to the loss of bone tissue.

The virtual elimination of childhood rickets in the industrialized countries has been largely attributed to the addition of Vitamin D to milk, a practice that commenced in the 1930s in Canada and the United States.

Either Vitamin D2 (ergocalciferol) or D3 (cholecalciferol) can be added to foods. The two forms have similar biological activities and both are very sensitive to oxygen and moisture, and both interact with minerals. A dry stabilized form of Vitamin D, which contains an antioxidant (usually tocopherol) that protects activity even in the presence of minerals, is generally used for most commercial applications.

Low exposure to sunlight is a risk factor for Vitamin D deficiency and can be a problem among those who live in the more northerly or southerly latitudes.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Vitamin D supplementation. A micronutrient fortification supplement according to the present disclosure may comprise Vitamin D, per dose, in an amount of from 5 μg to 25 μg, such as from 10 μg to 25 μg, or from 15 μg to 20 μg, such as 20 μg.

Embodiments of a micronutrient fortification supplement according to the present disclosure may contain Vitamin B. The term “Vitamin B”, as used herein, refers to one or more of the B vitamins: Vitamin B1, Vitamin B2, Vitamin B3, Vitamin B5, Vitamin B6, Vitamin B7, Vitamin B9, and Vitamin B12.

Embodiments of a micronutrient fortification supplement according to the present disclosure may contain folate. Folate (Vitamin B9) plays a central role in the synthesis and methylation of nucleotides that intervene in cell multiplication and tissue growth. Its role in protein synthesis and metabolism is closely interrelated to that of Vitamin B12. The combination of severe folate deficiency and Vitamin B12 deficiency can result in megaloblastic anemia. Low intakes of folate are also associated with a higher risk of giving birth to infants with neural tube defects and possibly other birth defects, and with an increased risk of cardiovascular diseases, cancer, and impaired cognitive function in adults.

Several intervention trials have demonstrated that folic acid fortification lowers plasma homocysteine, even in populations with a relatively low prevalence of folate deficiency. Several lines of evidence indicate that even moderately elevated plasma homocysteine is an independent risk factor for cardiovascular disease and stroke, both leading causes of death in many countries, while there is still some controversy concerning the direction of causality.

The addition of folic acid to enriched grain products in the United States, a practice that was introduced in 1998, has since produced a substantial increase in average blood folate levels among women of child-bearing age. This has resulted in the virtual elimination of low serum folate and the lowering of plasma homocysteine in the population at large.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Folate supplementation. A micronutrient fortification supplement according to the present disclosure may comprise Folate, per dose, in an amount of from 50 μg DFE (dietary folate equivalents) to 1000 μg DFE, such as from 80 μg DFE to 600 μg DFE, or from 100 μg DFE to 500 μg DFE, such as 400 μg DFE.

Embodiments of a micronutrient fortification supplement according to the present disclosure may contain Vitamin B12. Vitamin B12 (cobalamin) is a cofactor in the synthesis of an essential amino acid, methionine. Its metabolic role is closely linked to that of folate in that one of the Vitamin B12-dependent enzymes, methionine synthase, is vital to the functioning of the methylation cycle in which 5-methyltetrahydrofolate acts as a source of methyl donor groups which are necessary for cell metabolism and survival. Deficiency of this vitamin can thus impair the utilization of folate and causes neurological deterioration, megaloblastic anemia, elevated plasma homocysteine and possibly, impaired immune function. In infants and young children it can cause severe developmental delays.

Vitamin B12 is synthesized by microorganisms in the gut of animals and is subsequently absorbed and incorporated into animal tissues. Products from herbivorous animals (e.g. meat, eggs, and milk) are thus the only source of the vitamin for humans. Consequently, intakes are very low or close to zero in many population groups that are economically disadvantaged, or among those who avoid animal products for religious or other reasons. There is a high risk of deficiency in strict vegetarians and even lacto-ovo vegetarians (i.e. milk and egg consumers) have lower plasma concentrations of the vitamin compared with meat-consumers. Low maternal intake and/or status in the lactating mother will lead to inadequate amounts of Vitamin B12 in breast milk, and subsequently, deficiency in the infant. Malabsorption syndromes and some inborn errors of metabolism are also risk factors for Vitamin B12 deficiency.

Moderate to severe Vitamin B12 deficiency results in megaloblastic anemia and the demyelination of the central nervous system, and, in turn, various neurological disorders. The latter are variably reversible after correction of the deficiency.

Infants fed with breast milk from Vitamin B12 deficient mothers exhibited a failure to thrive, poor brain development and, in some cases, mental retardation.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Vitamin B12 supplementation. A micronutrient fortification supplement according to the present disclosure may comprise Vitamin B12, per dose, in an amount of from 0.1 μg to 5 μg, such as from 0.5 μg to 3 μg, or from 2 μg to 3 μg, such as 2.4 μg.

Embodiments of a micronutrient fortification supplement according to the present disclosure may contain other B vitamins. As the food sources of the various B-complex vitamins are similar, it is not surprising that diets inadequate in one B vitamin are more than likely to be deficient in the others. These water-soluble vitamins are readily destroyed during cooking in water and by heat (although niacin is stable to heat). More significantly, the milling and degerming of cereal grains removes almost all of the thiamine (Vitamin B1), riboflavin (Vitamin B2) and niacin (Vitamin B3), which is the reason why restoration of these particular nutrients to wheat and corn flour has been widely practiced for the last 60 years. This strategy has certainly contributed to the virtual elimination of Vitamin B deficiencies and their associated diseases (e.g., beriberi and pellagra) in the industrialized countries.

Historically, little attention has been paid to the assessment of thiamine, riboflavin, niacin and Vitamin B6 status. One of the reasons why these B-complex vitamins have been neglected in the past is the lack of reliable information about the consequences of marginal or subclinical deficiencies. However, evidence is mounting that Vitamin B deficiencies are highly prevalent in many developing countries, in particular where diets are low in animal products, fruits, and vegetables, and where cereals are milled prior to consumption. Pregnant and lactating women, infants, and children are at the highest risk of deficiency. Because the mother's intake and body stores of these vitamins affect the amount she secretes in breast milk, appropriate fortification can provide her with a steady supply during lactation and thereby improve the Vitamin B status of her infants and young children.

Embodiments of a micronutrient fortification supplement according to the present disclosure may include thiamine. Thiamine (Vitamin B1) is a cofactor for several key enzymes involved in carbo-hydrate metabolism and is also directly involved in neural function. It is likely that thiamine deficiency, in its subclinical form, is a significant public health problem in many parts of the world. Severe deficiency causes beriberi, a disease that was once commonplace among populations with a high carbohydrate intake, especially in the form of white rice. As mentioned above, beriberi has been largely eradicated in most industrialized countries, but the disease still occurs in some Asian countries where rice is the staple food. In addition, outbreaks of beriberi are regularly reported in regions suffering social and economic stress brought about by war, famine, and other emergency situations.

The main sources of thiamine are wheat germ and yeast extracts, offal from most animals, legumes (e.g., pulses, groundnuts, and beans), and green vegetables. A low intake of animal and dairy products and legumes and a high consumption of refined rice and cereals are, thus, the main risk factors for thiamine deficiency.

There are two distinct forms of severe thiamine deficiency: an edematous form known as wet beriberi and a non-edematous neurological form known as dry beriberi. The wet form is associated with potentially fatal heart failure, whereas the dry form tends to be chronic and results in peripheral neuropathy. Many cases of thiamine deficiency present with a mixture of symptoms and, thus, are properly termed “thiamine deficiency with cardiomyopathy and peripheral neuropathy.” Thiamine deficiency in infants is rarely seen today and is largely confined to infants who are breastfed by thiamine-deficient mothers. In such cases, it is almost always an acute disease, involving edema and cardiac failure with a high fatality rate.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Thiamine (Thiamin) supplementation. A micronutrient fortification supplement according to the present disclosure may comprise Thiamine, per dose, in an amount of from 0.1 mg to 2 mg, such as from 0.3 mg to 1.4 mg, or from 0.5 mg to 1.4 mg, such as 1.2 mg.

Embodiments of a micronutrient fortification supplement according to the present disclosure may contain riboflavin. Riboflavin (Vitamin B2) is a precursor of various nucleotides, most notably Flavin mononucleotide (FMN) and flavin adenine dinucleotide (FAD), which act as coenzymes in various metabolic pathways and in energy production. Riboflavin deficiency rarely occurs in isolation, and is frequently associated with deficiencies in one or more of the other B-complex vitamins.

The main dietary sources of riboflavin are meat and dairy products; only small amounts are found in grains and seeds. Leafy green vegetables are also a fairly good source of riboflavin and in developing countries tend to be the main source of the vitamin. Deficiency is thus likely to be more prevalent among those whose intake of animal source foods is low. In common with several of the other B-complex vitamins, chronic alcoholism is also a risk factor.

Symptoms of riboflavin deficiency are non-specific. Early symptoms may include weakness, fatigue, mouth pain, burning eyes, and itching. More advanced deficiency is characterized by dermatitis, brain dysfunction, and microcytic anemia. Riboflavin deficiency also reduces the absorption and utilization of iron for hemoglobin synthesis. It is possible that riboflavin deficiency is a contributory factor in the high prevalence of anemia worldwide.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Riboflavin supplementation. A micronutrient fortification supplement according to the present disclosure may comprise Riboflavin, per dose, in an amount of from 0.1 mg to 2 mg, such as from 0.4 mg to 1.6 mg, or from 1 mg to 1.5 mg, such as 1.3 mg.

Embodiments of a micronutrient fortification supplement according to the present disclosure may contain Niacin. Niacin (nicotinic acid or Vitamin B3), as a functional group of the coenzymes nicotinamide adenine dinucleotide (NAD) and its phosphate (NADP), is essential for oxidative processes. Deficiency results in pellagra and is associated with a heavily cereal-based diet that is low in bioavailable niacin, tryptophan, and other micronutrients needed for the synthesis of niacin and tryptophan. Niacin is unique among the vitamins in that at least part of the body's requirement for it can be met through synthesis from the amino acid tryptophan.

Pellagra was widespread in parts of southern Europe and in the United States during the 19th and early 20th centuries, but fortification of cereal grain products has since all but eradicated the condition from industrialized countries. It is, however, still common in India and in parts of Africa and China, especially where populations are dependent on maize-based diets.

Niacin is widely distributed in plant and animal foods. The main sources are baker's yeast, animal and dairy products, cereals, legumes, and leafy green vegetables. Niacin depletion is a risk where diets rely heavily on refined grains or grain products and have little variety. Severe deficiency, pellagra, is predominantly found in people who consume diets that are deficient in bioavailable niacin and low in tryptophan, such as maize- or sorghum-based diets.

Clinical signs of niacin deficiency, pellagra, develop within 2 to 3 months of consuming a diet inadequate in niacin and/or tryptophan. The most characteristic sign of pellagra is a symmetrically pigmented rash on areas of skin exposed to sunlight. Other manifestations include changes in the mucosa of the digestive tract, leading to oral lesions, vomiting, and diarrhea, and neurological symptoms such as depression, fatigue, and loss of memory.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Niacin supplementation. A micronutrient fortification supplement according to the present disclosure may comprise Niacin, per dose, in an amount of from 1 mg to 20 mg, such as from 4 mg to 18 mg, or from 10 mg to 20 mg, such as 16 mg.

Embodiments of a micronutrient fortification supplement according to the present disclosure may contain Vitamin B5 (pantothenic acid). Vitamin B5 is an essential nutrient that is important for the synthesis of coenzyme A and acyl carrier protein. Vitamin B5 deficiency is rare but can occur in people with severe malnutrition. A Vitamin B5 deficiency is associated with numbness and burning of hands and feet, headache, fatigue, irritability, and loss of appetite. Some dietary sources of Vitamin B5 include chicken, organ meats, whole grains, lentils, sweet potatoes and broccoli.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Pantothenic acid supplementation. A micronutrient fortification supplement according to the present disclosure may comprise Pantothenic acid, per dose, in an amount of from 1 mg to 10 mg, such as from 1.8 mg to 7 mg, or from 2 mg to 6 mg, such as 5 mg.

Embodiments of a micronutrient fortification supplement according to the present disclosure may contain Vitamin B6. Vitamin B6 is a group of three naturally-occurring compounds: pyridoxine (PN) and pyridoxal (PL). The different forms of Vitamin B6 are phosphorylated and then oxidized to generate pyridoxal 5′-phosphate (PLP), which serves as a carbonyl-reactive coenzyme to various enzymes involved in the metabolism of amino acids. Vitamin B6 deficiency alone is relatively uncommon, but occurs most often in association with deficiencies of the other B vitamins.

Vitamin B6 is widely distributed in foods, but meats, wholegrain products, vegetables, and nuts are especially good sources of the vitamin. Cooking and storage losses range from a few percent to nearly half of the Vitamin B6 originally present. Plants generally contain pyridoxine (PN), the most stable form, while animal products contain the less stable pyridoxal (PL) and the functional PLP form. In common with several of the other B vitamins, low intakes of animal products and a high consumption of refined cereals are the main risk factors for Vitamin B6 deficiency.

Symptoms of severe Vitamin B6 deficiency are non-specific and include neurological disorders, convulsions, skin changes, dermatitis, glossitis, cheilosis, and possibly anemia. Vitamin B6 deficiency is a risk factor for elevated plasma homocysteine. In trials, Vitamin B6 supplements increased secretion of the vitamin in the breast milk of lactating women.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Vitamin B6 supplementation. A micronutrient fortification supplement according to the present disclosure may comprise Vitamin B6, per dose, in an amount of from 0.1 mg to 3 mg, such as from 0.3 mg to 1.7 mg, or from 1.5 mg to 2 mg, such as 1.7 mg.

Embodiments of a micronutrient fortification supplement according to the present disclosure may contain Vitamin B7 (Biotin). Vitamin B7 contributes to the maintenance of skin, hair, and mucous membranes, metabolic activity, and healthy blood sugar levels. Vitamin B7 deficiency is rare and symptoms include hair loss, skin rash on the face, depression, and lethargy. Non-limiting examples of sources of Vitamin B7 include egg yolk, liver, sunflower seeds, and yeast.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Biotin supplementation. A micronutrient fortification supplement according to the present disclosure may comprise Biotin, per dose, in an amount of from 1 μg to 40 μg, such as from 6 μg to 35 μg, or from 8 μg to 30 μg, such as 30 μg.

Embodiments of a micronutrient fortification supplement according to the present disclosure may contain Vitamin C. Vitamin C is a redox system comprised of ascorbic acid and dehydroascorbic acid, and, as such, acts as an electron donor. Its main metabolic function is the maintenance of collagen formation. It is also an important antioxidant. Although severe Vitamin C deficiency (scurvy) is now relatively rare, the prevalence of milder or marginal deficiency is probably quite high.

Despite its near eradication, severe Vitamin C deficiency (scurvy) still occurs periodically in displaced populations maintained for long periods of time on food aid and without access to fresh fruit and vegetables. Outbreaks have been repeatedly reported from refugee camps in the Horn of Africa (i.e., Ethiopia, Kenya, Somalia, Sudan) and Nepal. In the mid-1980s, the prevalence of scurvy in refugee camps in north-west Somalia varied between 7-44 percent; in eastern Sudan the prevalence rate was 22 percent. Scurvy has also been observed in selected population groups, such as infants, and in some communities of mine laborers.

Vitamin C is widely available in foods of both plant and animal origin, but the best sources are fresh fruits and vegetables, and offal. As germination increases Vitamin C content, germinated grains and pulses also contain high levels of Vitamin C. However, because Vitamin C is unstable when exposed to an alkaline environment or to oxygen, light, and heat, losses may be substantial during storage and cooking.

Deficiency is usually a result of a low consumption of fresh fruits and vegetables, caused by any one or a combination of factors such as seasonal unavailability, transportation difficulties, and/or unaffordable cost. Displaced populations who rely on cooked, fortified rations and who do not have access to fresh fruits and vegetables are at a high risk for deficiency. For these population groups, Vitamin C supplementation is recommended, at least until they are able to obtain a more normal diet. Chronic alcoholics, institutionalized elderly, and people living on a restricted diet containing little or no fruits and vegetables are also at risk of Vitamin C deficiency. As the Vitamin C content of cow's milk is low, infants represent a further subgroup that is potentially high risk for Vitamin C deficiency. There have been a number of reports—across several world regions—of scurvy in infants fed on evaporated cow's milk.

The clinical symptoms of scurvy include follicular hyperkeratosis, hemorrhagic manifestations, and swollen joints, swollen bleeding gums and peripheral edema, and even death. These symptoms appear within 3-4 months of consuming diets with a very low Vitamin C content (appx. 2 mg per day). In infants, manifestations of scurvy include a hemorrhagic syndrome, signs of general irritability, tenderness of the legs, and pseudo paralysis involving the lower extremities. The adverse effects of mild deficiency are uncertain, but may include poor bone mineralization (due to slower production of collagen), lassitude, fatigue, anorexia, muscular weakness, and increased susceptibility to infections.

As Vitamin C increases the absorption of iron from foods, a low intake of Vitamin C will exacerbate any iron deficiency problems, especially in individuals who consume only small amounts of meat, fish or poultry. Indeed, anemia is a frequent manifestation of scurvy. The addition of Vitamin C to iron-fortified foods greatly improves the absorption of the iron. In Chile, for example, it was necessary to also add Vitamin C to iron fortified dried milk consumed by young children before any significant improvements in iron status could be detected.

Ascorbic acid and ascorbyl palmitate are often added to oils, fats, soft drinks, and various other foods as a way of improving the stability of other added micronutrients (e.g., Vitamin A) or as an iron absorption enhancer. However, ascorbic acid is itself relatively unstable in the presence of oxygen, metals, humidity, and/or high temperatures. To retain Vitamin C integrity, especially during storage, foods must therefore be appropriately packaged, or the ascorbic acid encapsulated.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Vitamin C supplementation. A micronutrient fortification supplement according to the present disclosure may comprise Vitamin C, per dose, in an amount of from 1 mg to 150 mg, such as from 15 mg to 120 mg, or from 50 mg to 100 mg, such as 90 mg.

Embodiments of a micronutrient fortification supplement according to the present disclosure may contain calcium. Calcium is the most abundant mineral in the body. Most (approx. 99 percent) of the body's 1000-1200 g of calcium is located in the skeleton where it exists as hydroxyapatite. In addition to its role in maintaining the rigidity and strength of the skeleton, calcium is involved in a large number of metabolic processes, including blood clotting, cell adhesion, muscle contraction, hormone and neurotransmitter release, glycogen metabolism, and cell proliferation and differentiation.

Osteoporosis, a disease characterized by reduced bone mass and, thus, increased skeletal fragility and susceptibility to fractures, is the most significant consequence of a low calcium status. Although an adequacy of calcium is important during the whole life span, it is especially important during childhood and adolescence (as these are periods of rapid skeletal growth), and for post-menopausal women and the elderly whose rate of bone loss is high.

The numerous metabolic roles of calcium are sustained even when intakes are low because calcium is withdrawn from the bone, homeostatic mechanisms fail to maintain an adequate calcium status in the extracellular fluid. Thus, inadequate calcium intakes lead to decreased bone mineralization and subsequently an increased risk for osteoporosis in adults

Although rickets is usually associated with Vitamin D deficiency, rickets has been observed in Vitamin D-replete infants who also had low calcium intakes.

Compared with other micronutrients, calcium is required in relatively large amounts. A heightened awareness of the need to increase intakes of calcium for osteoporosis prevention has meant that calcium fortification has attracted a good deal of interest in recent years.

Calcium salts are suitable for use as food fortification. Bioavailable forms recommended for the fortification of infant formulas and complementary foods include the carbonate. The cost of calcium carbonate is very low, usually less than that of flour.

In general, absorption of added calcium is similar to that naturally present in foods, which ranges from about 10-30 percent. However, high levels of calcium inhibit the absorption of iron from foods and so this too is something that needs to be taken into consideration when deciding how much calcium to add. The co-addition of ascorbic acid can help overcome the inhibitory effect of calcium on iron absorption. Thus, the addition of calcium can be beneficial in pregnant females having iron deficiencies when added in sufficient effective amounts in order to aid in iron abosorption.

Embodiments of a micronutrient fortification supplement according to the present disclosure may be formulated to meet and or exceed the FAO and WHO RNIs and EARs, DVs of the FDA, and/or the NAS DRI & RDA guidelines regarding calcium supplementation.

Embodiments of a micronutrient fortification supplement according to the present disclosure may contain selenium. Selenium is an essential element and a key constituent of at least 13 selenoproteins. These can be grouped into a number of distinct families, the glutathione peroxidases and the thioredoxin reductases, which are part of the antioxidant defense system of cells, and iodothyronine deiodinase, an enzyme which converts the inactive precursor of thyroxine, tetraiodothyronine (T4) into the active form, tri-iodothyronine (T3). In humans, the biological roles of selenium include the protection of tissues against oxidative stress, the maintenance of the body's defense systems against infection, and the modulation of growth and development. Severe deficiency can result in Keshan or Kaschin-Beck disease, which is endemic in several world regions.

Selenium deficiency is endemic in some regions of China, where Keshan disease was first described, and also in parts of Japan, Korea, Scandinavia, and Siberia. Endemic deficiency tends to occur in regions characterized by low soil selenium. For example, the distribution of Keshan disease and Kaschin-Beck disease in China reflects the distribution of soils from which selenium is poorly available to rice, maize, wheat, and pasture grasses. Fortification of salt and/or fertilizers with selenium is crucial in these parts of the world.

Keshan disease is a cardiomyopathy associated with a low selenium intake and low levels of selenium in blood and hair. Reports of its occurrence across a wide zone of mainland China first appeared in the mainstream scientific literature in the 1930s. Because some features of Keshan disease cannot be explained by selenium deficiency alone, other contributing factors have been suggested, in particular, infection with the cocksackie virus.

Low intake of selenium has been linked to a reduced conversion of the thyroid hormone, T4 to T3. The metabolic interrelations between selenium and iodine are such that deficiencies in one can sometimes exacerbate problems with the other. In the Democratic Republic of Congo, for instance, combined selenium and iodine deficiencies were shown to contribute to endemic myxedematous cretinism. Administration of selenium alone appeared to aggravate this disease; by restoring selenium-dependent deiodinase activity, the synthesis and use of thyroxine (T4) and iodine is increased, thereby exacerbating the iodine deficiency. Some researchers have also associated low selenium intakes with an increased incidence of cancer, in particular, esophageal cancer, and also with cardiovascular disease.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Selenium supplementation. A micronutrient fortification supplement according to the present disclosure may comprise Selenium, per dose, in an amount of from 10 μg to 80 μg, such as from 20 μg to 70 μg, or from 20 μg to 60 μg, such as 55 μg.

Embodiments of a micronutrient fortification supplement according to the present disclosure may contain fluoride. Unlike the other micronutrients considered in the guidelines, fluoride is not generally considered to be an essential nutrient according to the strict definition of the term; nevertheless, fluoride is undoubtedly protective against tooth decay.

The prevalence of dental cavities is 40-60 percent lower in those areas of the United States where water is fluoridated compared with those where it is not.

If ingested in water or foods, fluoride will become incorporated into the mineral of growing teeth and, thus, make them more resistant to decay. Continued exposure of the tooth surfaces to fluoride throughout life is also beneficial because it reduces the ability of bacteria to cause decay and promotes the re-mineralization of decayed areas.

Embodiments of a micronutrient fortification supplement according to the present disclosure may be formulated to meet and or exceed the FAO and WHO RNIs and EARs, in addition to the NAS DRI & RDA guidelines regarding fluoride supplementation.

Embodiments of a micronutrient fortification supplement according to the present disclosure may contain Vitamin E. Vitamin E is an antioxidant vitamin, which may be in the form of alpha-tocopherol. Vitamin E deficiency is rare, but may occur as a consequence of abnormalities in dietary fat absorption or metabolism. Vitamin E deficiency due to either malabsorption or metabolic anomaly can cause nerve problems due to poor conduction of electrical impulses along nerves due to changes in nerve membrane structure and function. Vitamin E deficiency can cause ataxia, peripheral neuropathy, myopathies, retinopathy, and impairment of immune responses. Non-limiting sources of Vitamin E include vegetable oils, avocados, spinach, sunflower seeds, wheat germ, and whole grains.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Vitamin E supplementation. A micronutrient fortification supplement according to the present disclosure may comprise Vitamin E, per dose, in an amount of from 1 mg to 20 mg, such as from 5 mg to 19 mg, or from 10 mg to 20 mg, such as 15 mg.

Embodiments of a micronutrient fortification supplement according to the present disclosure may contain Vitamin K. The term “Vitamin K”, as used herein, refers to one or more of the K vitamins, Vitamin K1 (phylloquinone) and Vitamin K2 (menaquinone). Vitamin K produces proteins that help the blood to clot, which prevents excessive bleeding internally and externally. While vitamin K deficiency is rare, it means a person's body cannot produce enough of these proteins, increasing the risk of excessive bleeding. Non-limiting sources of Vitamin K include vegetables, such as spinach and broccoli, vegetable oils, and some fruits.

Embodiments of a micronutrient fortification supplement according to the present disclosure may contain manganese. Manganese is involved in the formation of bone and in amino acid, lipid, and carbohydrate metabolism. Manganese deficiency can cause serious health threats including bone loss, muscle and joint pain, and mood changes. Non-limiting examples of manganese sources include nuts, legumes, seeds, whole grains, and leafy green vegetables.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Manganese supplementation. A micronutrient fortification supplement according to the present disclosure may comprise Manganese, per dose, in an amount of from 0.5 mg to 5 mg, such as from 0.6 mg to 3 mg, or from 2 mg to 3 mg, such as 2.3 mg.

Embodiments of a micronutrient fortification supplement according to the present disclosure may contain chromium. Chromium, as the trivalent form Cr³⁺, enhances insulin function and influences carbohydrate, protein, and fat metabolism. Chromium deficiency is a widespread problem which can result in diabetes and atherosclerosis, as well as altered cholesterol metabolism, decreased growth in children, and delayed healing time. Symptoms of chromium deficiency include severely impaired glucose tolerance, weight loss, peripheral neuropathy, and confusion. Mild chromium deficiencies can results in problems in blood sugar metabolism, anxiety, or fatigue. Non-limiting examples of dietary chromium sources include mussels, broccoli, potatoes, and oranges.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Chromium supplementation. A micronutrient fortification supplement according to the present disclosure may comprise Chromium, per dose, in an amount of from 5 μg to 50 μg, such as from 5.5 μg to 45 μg, or from 30 μg to 40 μg, such as 35 μg.

Embodiments of a micronutrient fortification supplement according to the present disclosure may contain copper. Copper is an essential trace element which aids in iron absorption, is involved in the formation of red blood cells, the metabolism of cholesterol and glucose, and the synthesis of life-sustaining proteins and enzymes. Copper is essential for the normal growth and development of human fetuses, infants, and children. Severe deficiency of copper in pregnant mothers increases the risk of health problems in their fetuses and infants, such as low birth weight, muscle weaknesses, and neurologic problems. Copper deficiency can cause many hematological manifestations, including anemia, low white blood cell count, and myelodysplasia. Non-limiting examples of dietary copper sources include oysters, whole grains, beans, nuts, dark leafy greens, and potatoes.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Copper supplementation. A micronutrient fortification supplement according to the present disclosure may comprise Copper, per dose, in an amount of from 0.1 mg to 1.5 mg, such as from 0.2 mg to 1.3 mg, or from 0.3 mg to 1 mg, such as 0.9 mg.

Embodiments of a micronutrient fortification supplement according to the present disclosure may contain molybdenum. Molybdenum functions as a cofactor for important enzymes. Molybdenum deficiency is rare, but can cause severe symptoms such as increased heart rate, mouth and gum disorders, and sulfite sensitivity. Non-limiting examples of dietary molybdenum sources include beans, legumes, whole grains, nuts, and dark leafy greens.

Embodiments of a micronutrient fortification supplement according to the present disclosure may be formulated to meet and/or exceed the FAO and WHO RNIs and EARs, DVs of the FDA, and/or the NAS DRI & RDA guidelines regarding Molybdenum supplementation. A micronutrient fortification supplement according to the present disclosure may comprise Molybdenum, per dose, in an amount of from 1 μg to 60 μg, such as from 3 μg to 45 μg, or from 15 μg to 50 μg, such as 45 μg.

Embodiments of a micronutrient fortification supplement according to the present disclosure may contain other micronutrients, such as phosphorus, magnesium, chloride, and/or choline.

The micronutrients used in the composition of the present invention may be 100% plant-based. By “100% plant-based”, it is meant that the micronutrient fortification supplement consists of ingredients derived from plants. including vegetables, grains, nuts, seeds, legumes and fruits.

The micronutrient fortification supplement of the disclosure may be used as a food and/or beverage additive. Such powder and/or granular compositions allow the micronutrient fortification product to be capable of being dispersed on a prepared food or beverage product, for example, upon opening a sealed sachet.

Food and beverage additives of the present disclosure can include a micronutrient fortification supplement as described herein and a flavoring agent. The flavoring agent of the present invention may comprise salt, sugar, one or more herbs, one or more spices, one or more seasonings, one or more powdered food products, and combinations thereof. The flavoring agent may comprise at least one seasoning or spice. A “seasoning”, as used herein, refers to a mixture of salt, herbs, or spices. Non-limiting examples of spices which may be used with the present invention include mustard, onion, garlic, paprika, pepper, cinnamon, and combinations thereof.

The flavoring agent of the present invention may comprise at least one natural or organic component, or may consist of only natural and/or organic components. By “natural” it is meant a flavoring agent component that contains only ingredients produced by nature, and contains no artificial or synthetic additives, such as hormones, sweeteners, or color additives. By “organic” it is meant a flavoring agent component that complies with the U.S. Department of Agriculture guidelines for certified organic foods. The organic flavoring agent component may have 100% certified organic ingredients (100% Organic) or at least 95% certified organic ingredients (Organic).

The amount of flavoring agent in the food and beverage additives of the present disclosure may be greater than the amount of the micronutrient fortification supplement, based on mass. The ratio of micronutrient fortification supplement to flavoring agent in the food and beverage additive may be in a range of from 1:1 to 10:1, such as from 2:1 to 10:1, from 2:1 to 5:1, or from 2:1 to 4:1, such as 3:1, based on mass.

The micronutrient fortification supplement can comprise at least 1 weight %, at least 5 weight %, at least 10 weight %, at least 20 weight %, or at least 30 weight % of the food and beverage additive, based on total solids weight of the food and beverage additive. The micronutrient fortification supplement can comprise up to 50 weight %, up to 40 weight %, or up to 30 weight % of the food and beverage additive, based on total solids weight of the food and beverage additive. The micronutrient fortification supplement can comprise an amount within a range such as from 1 to 50 weight %, from 5 to 40 weight %, or from 10 to 30 weight % of the food and beverage additive, based on total solids weight of the food and beverage additive.

The flavoring agent can comprise at least 50 weight %, at least 60 weight %, at least 70 weight %, or at least 80 weight % of the food and beverage additive, based on total solids weight of the food and beverage additive. The flavoring agent can comprise up to 99 weight %, up to 90 weight %, or up to 80 weight % of the food and beverage additive, based on total solids weight of the food and beverage additive. The flavoring agent can comprise an amount within a range such as from 50 to 90 weight %, from 60 to 80 weight %, or from 70 to 90 weight % of the food and beverage additive, based on total solids weight of the food and beverage additive.

The food and beverage additives of the present disclosure may have a serving size or dose in a range of from 500 mg to 10 g, such as from 1 g to 5 g, such as from 1 g to 3 g. The food and beverage additives of the present disclosure may contain at least 10 different micronutrients, at least 15 different micronutrients, or at least 20 different micronutrients. The food and beverage additives of the present disclosure may contain a total of from 10 to 30 micronutrients, such as from 15 to 25 micronutrients, or from 20 to 25 micronutrients, such as 21 micronutrients.

The food and beverage additives of the present disclosure may contain each micronutrient in an amount equal to or greater than the Daily Values (DVs) recommended by the FDA. Each micronutrient may be present in an amount that meets or exceeds the DVs for adults and children 4 years and older, infants through 12 months, children 1 through 3 years, or pregnant and lactating women. Each micronutrient may be present in an amount equal to the DVs of the FDA. Alternatively, each micronutrient may be present in an amount lower than the DV of the FDA, such as 50% of the DV of the FDA.

Non-limiting embodiments of a food and beverage additive according to the present disclosure may include one or more of the above components for purposes of treating the above-described and/or identified conditions, diseases, or defects described herein. Although only certain micronutrients have been described herein above and below, it is contemplated that other micronutrients effective for treating one or more of the above-identified or other conditions, diseases, or defects may be included with embodiments of the present disclosure. These combinations, such as shown and described in the below examples and above, result in the advantage that micronutrient supplement or food additive is achieved that provides the herein described health benefits of each micronutrient individually at or exceeding the recommended daily value amounts in a single supplement or food additive package while also providing an optimum flavor profile. An example of one embodiment of a composition of a food and beverage additive according to the present disclosure may have a formulation per serving size as follows:

TABLE 1
MICRONUTRIENT FORTIFICATION SUPPLEMENT 1

| MICRONUTRIENTS | Amount | | % DV^{a} |
|---|---|---|---|
| VITAMIN A (BETA CAROTENE) | 900 μg RAE | | 100 |
| VITAMIN C | 90 | mg | 100 |
| VITAMIN D2 | 20 | μg | 100 |
| VITAMIN E | 15 | mg | 100 |
| VITAMIN B1 (THIAMINE) | 1.2 | mg | 100 |
| VITAMIN B2 (RIBOFLAVIN) | 1.3 | mg | 100 |
| VITAMIN B3 (NIACIN) | 16 | mg | 100 |
| VITAMIN B5 (PANTOTHENIC ACID) | 5 | mg | 100 |
| VITAMIN B6 | 1.7 | mg | 100 |
| VITAMIN B7 (BIOTIN) | 30 | μg | 100 |
| VITAMIN B9 (FOLATE) | 400 μg DFE | | 100 |
| VITAMIN B12 | 2.4 | μg | 100 |
| VITAMIN K1 | 120 | μg | 100 |
| CHROMIUM | 35 | μg | 100 |
| COPPER | 0.9 | mg | 100 |
| IODINE | 150 | μg | 100 |
| IRON | 18 | mg | 100 |
| MANGANESE | 2.3 | mg | 100 |
| MOLYBDENUM | 45 | μg | 100 |
| SELENIUM | 55 | μg | 100 |
| ZINC | 11 | mg | 100 |

^{a}Based on DV for Adults and children 4 years and older

Micronutrient fortification supplement 1 (MFS 1) shown in Table 1 includes 100% plant-based ingredients and has a serving size of 491 mg. It includes 21 micronutrients in the amounts shown in Table 1, which correspond to 100% DV.

TABLE 2
MICRONUTRIENT FORTIFICATION SUPPLEMENT 2

| MICRONUTRIENTS | Amount | | % DV |
|---|---|---|---|
| VITAMIN A (BETA CAROTENE) | 450 μg RAE | | 50 |
| VITAMIN C | 45 | mg | 50 |
| VITAMIN D | 10 | μg | 50 |
| VITAMIN E | 7.5 | mg | 50 |
| VITAMIN B1 (THIAMINE) | 0.6 | mg | 50 |
| VITAMIN B2 (RIBOFLAVIN) | 0.65 | mg | 50 |
| VITAMIN B3 (NIACIN) | 8 | mg | 50 |
| VITAMIN B5 (PANTOTHENIC ACID) | 2.5 | mg | 50 |
| VITAMIN B6 | 0.85 | mg | 50 |
| VITAMIN B7 (BIOTIN) | 15 | μg | 50 |
| VITAMIN B9 (FOLATE) | 200 μg DFE | | 50 |
| VITAMIN B12 | 1.2 | μg | 50 |
| VITAMIN K1 | 60 | μg | 50 |
| CALCIUM | 9 | mg | |
| CHOLINE | 275 | mg | |
| IODINE | 75 | μg | 50 |
| IRON | 9 | mg | 50 |
| MANGANESE | 1.15 | mg | 50 |
| PHOSPHORUS | 625 | mg | |
| SELENIUM | 27.5 | μg | 50 |
| ZINC | 5.5 | mg | 50 |

^{a}Based on DV for Adults and children 4 years and older

Micronutrient fortification supplement 2 (MFS 2) shown in Table 2 includes 22 micronutrients in the amounts shown in Table 2, which correspond to 50% DV.

The form of the micronutrients used in any particular formulation may change depending on the specifics of every application. For example, people in certain parts of the world can only absorb or take certain forms of micronutrients, or availability for certain forms of the micronutrients may be limited. Thus, the present disclosure is not limited to the particular form of the micronutrients, such as those identified in MFS 1 or MFS 2, as not all forms are suitable for all applications.

Some embodiments of a food and beverage additive according the present disclosure may be water soluble. For example, depending on the flavoring additives or components, the composition may be added to a drink.

TABLE 2
FOOD ADDITIVE EXAMPLE 1

| INGREDIENTS | Amount |
|---|---|
| MFS 1 | 0.5 g |
| SEASONING SALT | 1.5 g |

Micronutrient Fortification Supplement 1 and Seasoned Salt (including sea salt, garlic, paprika, and other spices) were mixed in the amounts shown in Table 2. Food Additive Example 1 has a serving size of 2 g.

### BEVERAGE ADDITIVE EXAMPLE 1

Micronutrient Fortification Supplement 1 and Organic Cinnamon were mixed to create a beverage additive.

Although the above-identified amounts/ratios of components are examples of effective doses for each component (micronutrients and flavoring agents) described herein, an effective dose or dose range is expected to vary from that of other compounds described herein for any number of reasons, including the molecular weight of the compound, bioavailability in the dosage form, route of administration, specific application, etc.

An embodiment of a method of manufacturing a food and beverage additive according to the present disclosure may include the mixing of those components identified in Table 1 or Table 2 with a flavoring agent. The method may also include sealing single dosages of the resulting composition into a sachet. The sachet may be similar to that of a sugar packet. However, the present disclosure contemplates that the sachet may be of any size necessary to contain within its interior the effective amounts of the composition and/or the desired dosage. The composition may be manufactured to take the form of a powder, it may be granular, or it may have characteristics of both. Such powder and/or granular compositions allow the micronutrient fortification product to be capable of being dispersed on a prepared food product upon opening a sealed sachet. The powder/granular compositions may be manufactured in any pharmacologically acceptable manner, such as those described generally in Chapter 37 of Troy, D B, Editor, Remington: The Science and Practice of Pharmacy, 21st Ed., Lippincott Williams & Wilkins (2005), the entirety of which is hereby incorporated by reference. The sachet may be made of biodegradable material and/or be biodegradable in its entirety, and, in developing countries, may, in some instances, be used as kindling.

In use, a subject, patient, or such subject/patient's caregiver or guardian would open the sachet and sprinkle the contents of the food and beverage additive composition onto a serving of prepared food, such as cooked rice, or to a beverage. A serving of cooked rice in this example may be any acceptable serving for a particular purposes, and may vary depending on the subject being served the rice. However, in some embodiments, the rice may be, for example, in the range of 0.5-16 ounces. For example, this amount may be 4 ounces, 100 grams, or any other acceptable serving. This provides the advantage of providing necessary nutrients to an otherwise nutrient deficient meal, although it is contemplated that it could be added to any prepared food. In normal circumstances, the food and beverage additive, such as the example formulation provided about in Table 3, would be provided as a single dose per day, e.g., with one meal. However, it is contemplated that dosages could be provided as often as needed depending on the particular application.

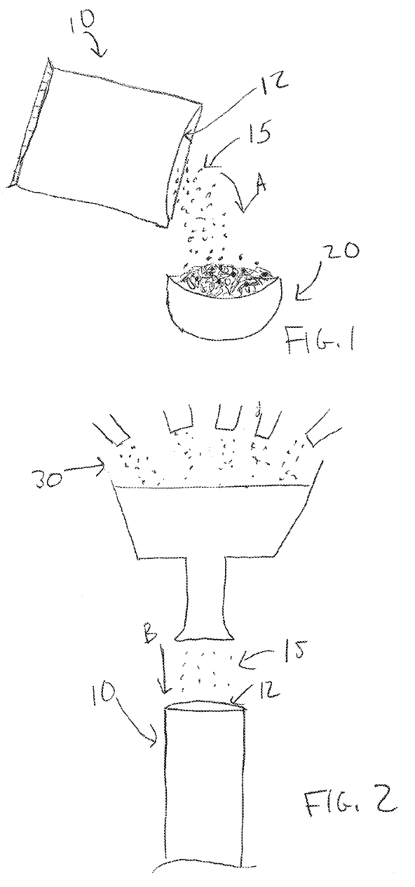

Referring now to FIG. 1, a sachet 10 is shown having a hollow interior chamber 12 in which a composition 15, shown in powder and/or granular form, according to the present invention, is shown. As depicted, the composition 15 may be poured over and dispersed and/or sprinkled, as illustrated by arrow A, over a bowl of prepared food 20, such as cooked rice. Referring to FIG. 2, a schematic representation of a method of manufacturing is shown, wherein the various components of the composition 15 are mixed at a point 30, such as a mixer or a hopper, wherein, subsequently, the composition 15 could then be filled, as illustrated by arrow B, into the hollow interior chamber 12 of a sachet 10. The sachet 10 manufacturing/filling process could be completed by sachet filling methods known by those skilled in the art. An example of a sachet filling device/method is illustrated in U.S. Pat. No. 5,063,727, which is herein incorporated by reference.

While the present disclosure has been described in terms of the above examples and detailed description, those of ordinary skill will understand that alterations may be made within the spirit of the invention. Thus, the present invention is capable of many variations in detailed implementation, which may be derived from the description contained herein by a person of ordinary skill in the art.

The invention claimed is:

1. A food and beverage additive comprising:
a micronutrient fortification supplement comprising at least 10 different micronutrients, and
a flavoring agent comprising at least one seasoning or spice.

2. The food and beverage additive of claim 1, wherein the micronutrients are 100% plant-based.

3. The food and beverage additive of claim 1, wherein the micronutrient fortification supplement comprises Vitamin A, Vitamin B, Vitamin C, Vitamin D, Vitamin E, Vitamin K, Zinc, Iodine, Iron, Manganese, and Selenium.

4. The food and beverage additive of claim 3, wherein the Vitamin B comprises Vitamin B1, Vitamin B2, Vitamin B3, Vitamin B5, Vitamin B6, Vitamin B7, Vitamin B9, and Vitamin B12.

5. The food and beverage additive of claim 3, wherein the Vitamin D comprises Vitamin D2.

6. The food and beverage additive of claim 3, wherein the Vitamin K comprises Vitamin K1.

7. The food and beverage additive of claim 3, wherein the micronutrient fortification supplement further comprises Chromium, Copper, and Molybdenum.

8. The food and beverage additive of claim 1, wherein the ratio of micronutrient fortification supplement to flavor additive is in a range of from 2:1 to 10:1, based on mass.

9. The food and beverage additive of claim 1, comprising each micronutrient in an amount which is equal to or greater than the Daily Value (DV) of the U.S. Food and Drug Administration (FDA).

10. The food and beverage additive of claim 1, wherein the flavoring agent comprises salt, garlic, paprika, onion, sugar, or cinnamon.

11. The food and beverage additive of claim 1, wherein the flavoring agent comprises at least one natural or organic component.

12. The food and beverage additive of claim 1, wherein the composition is a powder and/or granular.

13. A food and beverage additive comprising:
a micronutrient fortification supplement comprising Vitamin A, Vitamin B1, Vitamin B2, Vitamin B3, Vitamin B5, Vitamin B6, Vitamin B7, Vitamin B9, Vitamin B12, Vitamin C, Vitamin D2, Vitamin E, Vitamin K1, Zinc, Chromium, Copper, Iodine, Iron, Manganese, Molybdenum, and Selenium; and
a flavoring agent comprising at least one seasoning or spice.

14. The food and beverage additive of claim 13, wherein the micronutrients are 100% plant-based.

15. The food and beverage additive of claim 13, comprising each micronutrient in an amount which is equal to or greater than the Daily Value (DV) of the U.S. Food and Drug Administration (FDA).

16. The food and beverage additive of claim 13, wherein the flavoring agent comprises salt, garlic, paprika, onion, sugar, or cinnamon.

17. The food and beverage additive of claim 13, wherein the flavor agent comprises at least one natural or organic component.

18. The food and beverage additive of claim 13, comprising, per dose, 900 μg RAE (retinol activity equivalents) Vitamin A, 1.2 mg Vitamin B1, 1.3 mg Vitamin B2, 16 mg Vitamin B3, 5 mg Vitamin B5, 1.7 mg Vitamin B6, 30 μg Vitamin B7, 400 μg DFE (dietary folate equivalents), 2.4 μg Vitamin B12, 90 mg Vitamin C, 20 μg Vitamin D2, 15 mg Vitamin E, 120 μg Vitamin K1, 35 μg Chromium, 0.9 mg Copper, 150 μg Iodine, 18 mg Iron, 2.3 mg Manganese, 45 μg Molybdenum, 55 μg Selenium, and 11 mg Zinc.

19. The food and beverage additive of claim 13, wherein the composition is a powder and/or granular.

20. The food and beverage additive of claim 13, wherein the ratio of micronutrient fortification supplement to flavor additive is in a range of from 2:1 to 10:1, based on mass.
